(19) United States
(12) Patent Application Publication
(10) Pub. No.: US 2013/0002629 A1
(43) Pub. Date: Jan. 3, 2013

(54) ELECTRONIC DEVICE HAVING POWER SAVING DISPLAY MODE

(75) Inventor: WEI-DONG CONG, Shenzhen City (CN)

(73) Assignees: HON HAI PRECISION INDUSTRY CO.,LTD., Tu-Cheng (TW); HONG FU JIN PRECISION INDUSTRY (ShenZhen) CO.,LTD., Shenzhen City (CN)

(21) Appl. No.: 13/292,102

(22) Filed: Nov. 9, 2011

(30) Foreign Application Priority Data
Jul. 1, 2011 (CN) 201110184083.0

(51) Int. Cl. G09G 5/00

(52) U.S. Cl. 345/211

(57) ABSTRACT

An exemplary electronic device includes a display, a battery, a battery detection module, and a control module. The display displays an operation interface when the electronic device is powered on. The display includes a top section for displaying one part of the operation interface and a bottom section for displaying the other part of the operation interface. The battery provides power to the display. The battery detection module detects a residual electrical energy of the battery and for determines whether the residual electrical energy is lower than a predetermined threshold. The control module turns off the top section or the bottom section when the residual electrical energy is lower than the predetermined threshold.

### BACKGROUND

1. Technical Field

The present disclosure relates to electronic devices and, particularly, relates to a battery-powered electronic device that can reduce power consumption when the battery is low.

2. Description of Related Art

It is common for individuals to want to continue using their battery-powered electronic devices even when the battery is low. But on many such occasions, an alternative external power source or a battery charger are unavailable.

Therefore, it is desirable to provide an electronic device which can overcome the above-mentioned limitations.

### BRIEF DESCRIPTION OF THE DRAWINGS

FIG. 1 is a functional block diagram of an electronic device according to a first embodiment.

FIG. 2 is a schematic, top plan view of the electronic device of the first embodiment.

FIG. 3 is a flow chart of an exemplary control method of the electronic device of FIG. 1.

FIG. 4 is a functional block diagram of an electronic device according to a second embodiment.

FIG. 5 is a flow chart of an exemplary control method of the electronic device of FIG. 4.

### DETAILED DESCRIPTION

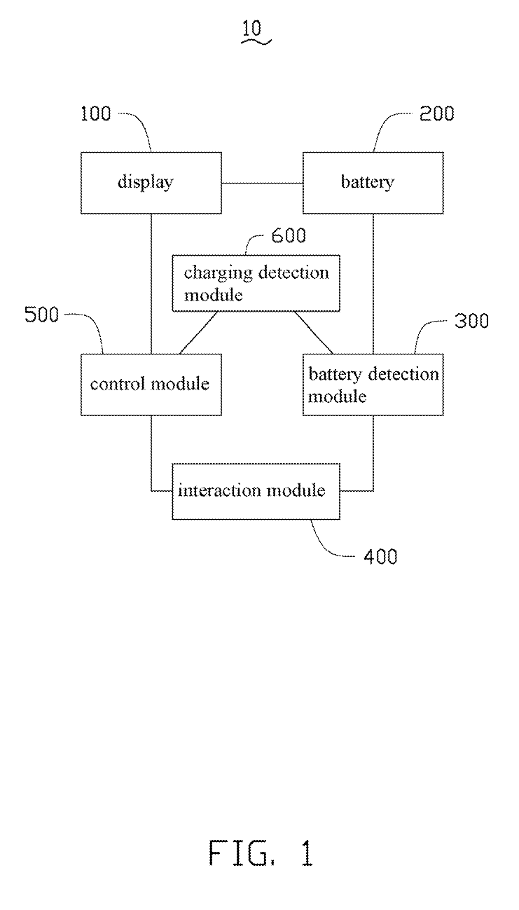

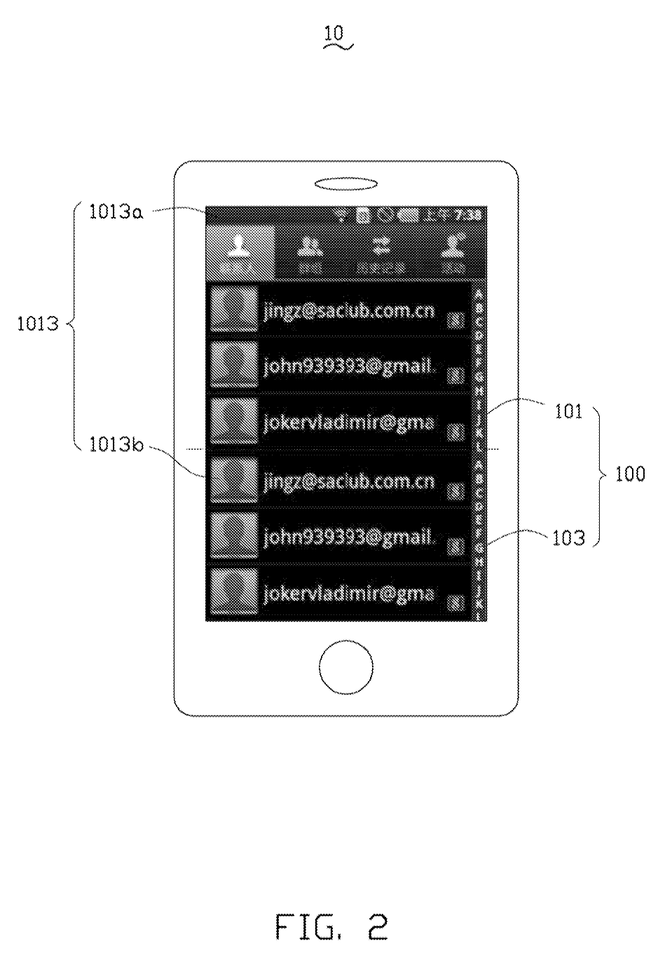

Referring to FIGS. 1-2, a portable electronic device 10, according to a first embodiment, is shown. The electronic device 10 includes a display 100, a battery 200, a battery detection module 300, an interaction module 400, a control module 500, and a charging detection module 600. In the present embodiment, the electronic device 10 is a cell phone.

The display 100 includes a screen, and is divided into a top section 101 and a bottom section 103. The top section 101 and the bottom section 103 both comprise a plurality of pixels, which can be programmatically controlled. The display 100 displays an operation interface 1013, e.g., a graphic user interface (GUI), for a user to interact with when the electronic device 10 is powered on. The top section 101 displays a part of the operation interface 1013a. The bottom section 103 displays the other part of the operation interface 1013b. In this embodiment, the display 100 is a liquid crystal display (LCD) panel, a light emitting diode (LED) panel, or an organic light emitting diode (OLED) panel.

The battery 200 is connected to the display 100 and provides power to the display 100. The capacity of the battery 200 is, for example, about 1200 milliamperes per hour (mAh).

The battery detection module 300 is connected to the battery 200 for continuously detecting a residual electrical energy (i.e. charge) of the battery 200 and determining whether the residual electrical energy is lower than a predetermined threshold. In alternative embodiment, the battery detection module 300 may periodically sample the residual electrical energy level of the battery 200. The battery detection module 300 generates an enable signal when the residual electrical energy is lower than the predetermined threshold, or generates a disable signal when the residual electrical energy is equal to or higher than the predetermined threshold. The predetermined threshold can be, for example, about 10% of the capacity of the battery 200. In the present example, the predetermined threshold is 20 mAh.

The interaction module 400 is connected to the battery detection module 300 and the control module 500. The interaction module 400 is activated when receiving the enable signal generated by the battery detection module 300, and generates a query message that is sent to the control module 500. The interaction module 400 is in an idle state when receiving the disable signal generated by the battery detection module 300.

The control module 500 is connected to the display 100. The control module 500 controls the query message to be displayed on the top section 101 or the bottom section 103. In this embodiment, the query message is displayed on the top section 101 as a dialog box. The dialog box reminds the user that the residual electrical energy is lower than the predetermined threshold, and prompts the user as to whether he/she wants to choose a power saving mode through the dialog box.

The control unit 500 turns off the top section 101 or the bottom section 103 when the user chooses the power saving mode through the dialog box. In this embodiment, the control unit 500 turns off the bottom section 103 when the user chooses the power saving mode.

The charging detection module 600 is connected to the battery detection module 300 to detect whether the battery 200 is being charged. In particular, the charging detection module 600 monitors the residual electrical energy of the battery 200. When the residual electrical energy is in an increasing state, it indicates that the battery 200 is being charged. The charging detection module 600 is further connected to the control module 500. The charge detection module 600 sends a restart signal to the control module 500 when detecting that the battery 200 is being charged. The control module 500 turns on the bottom section 103 again when receiving the restart signal.

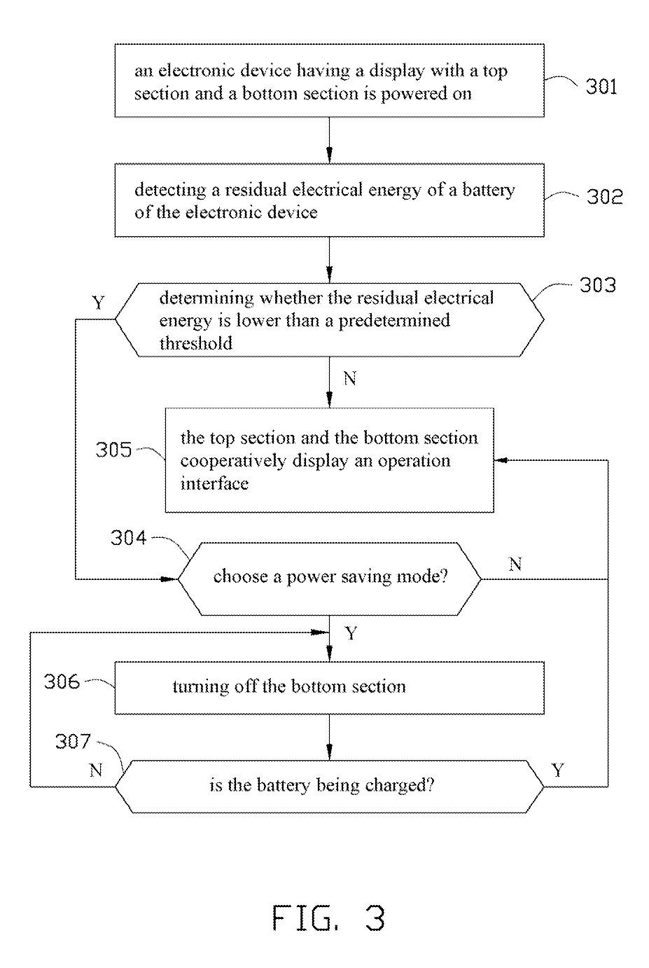

Referring to FIG. 3, a control method of the electronic device 10 is described below.

In step 301, the communication device 10 is powered on. Typically, the residual electrical energy is equal to or higher than the predetermined threshold, and the top section 101 and the bottom section 103 cooperatively display the operation interface 1013.

In step 302, the residual electrical energy of the battery 200 is detected by the battery detection module 300.

In step 303, the battery detection module 300 further determines whether the residual electrical energy is lower than the predetermined threshold. If the determination is yes, the battery detection module 300 generates an enable signal, whereupon the procedure goes to step 304. If the determination is no, the procedure goes to step 305.

In step 304, the interaction module 400 is activated when receiving the enable signal generated by the battery detection module 300, and generates a query message that is sent to the control module 500. The control module 500 controls the query message to be displayed on the top section 101 as a dialog box. The dialog box reminds the user that the residual electrical energy is lower than the predetermined threshold, and prompts the user as to whether he/she wants to choose a power saving mode through the dialog box. If the user's response is yes, the procedure goes to step 306. If the user's response is no, the procedure goes to step 305.

In step 305, the control module 500 controls the top section 101 and the bottom section 103 to cooperatively display the operation interface 1013.

In step 306, the control module 500 turns off the bottom section 103 to save power.

In step 307, the charging detection module 600 detects whether the battery 200 is being charged. If the determination is yes, the procedure goes to step 305. If the determination is no, the procedure goes to step 306.

In summary, the bottom section 103 is turned off by the control module 500 when the residual electrical energy is lower than the predetermined threshold, to save power. Therefore the standby time of the communication device 10 can be extended.

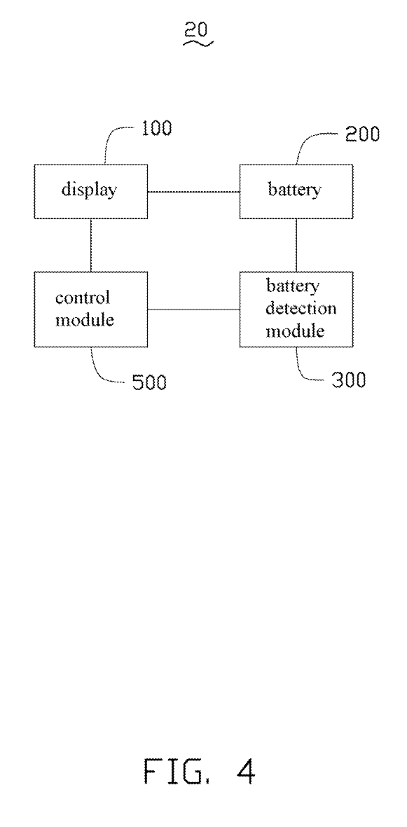

Referring to FIG. 4, an electronic device 20 according to a second embodiment is shown. The electronic device 20 includes a display 100, a battery 200, a battery detection module 300 and a control module 500.

In this second embodiment, compared to the first embodiment, the interaction module 400 and the charging detection module 600 are omitted. The display 100 includes the top section 101 and the bottom section 103 (see FIG. 2). The top section 101 and the bottom section 103 cooperatively display the operation interface 1013.

The battery 200 is connected to the display 100 and provides power to the display 100.

The battery detection module 300 is connected to the battery 100, for detecting a residual electrical energy of the battery 200 and determining whether the residual electrical energy is lower than the predetermined threshold.

The control module 500 is connected to the display 100 and the battery detection module 300. The control module 500 turns off the bottom section 103 when the residual electrical energy is lower than the predetermined threshold. The control module 500 keeps the bottom section 103 turned on when the residual electrical energy is equal to or higher than the predetermined threshold.

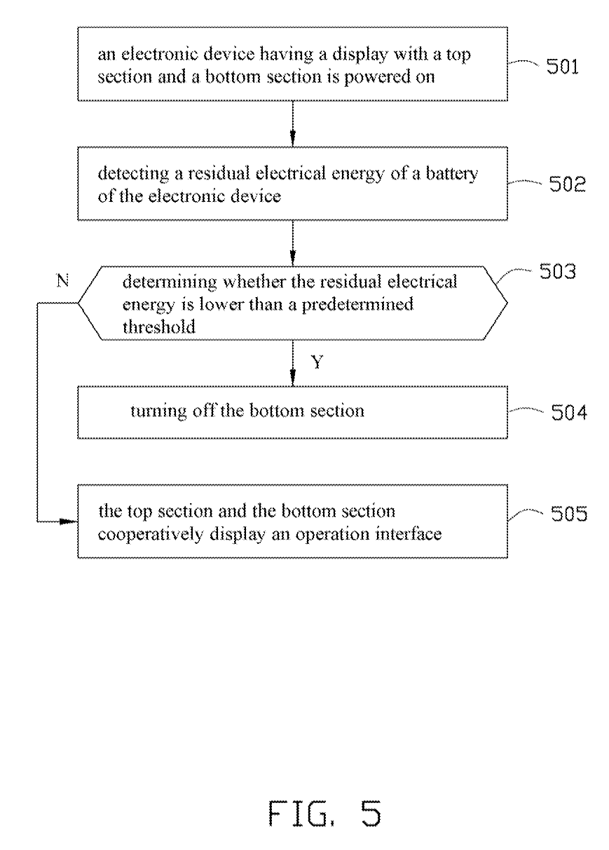

Referring to FIG. 5, a control method of the electronic device 20 is described below.

In step 501, the communication device 20 is powered on. Typically, the residual electrical energy of the battery 200 is equal to or higher than the predetermined threshold, and the top section 101 and the bottom section 103 cooperatively display the operation interface 1013.

In step 502, the residual electrical energy of the battery 200 is detected by the battery detection module 300.

In step 503, the battery detection module 300 further determines whether the residual electrical energy is lower than the predetermined threshold. If the determination is yes, the procedure goes to step 504. If the determination is no, the procedure goes to step 505.

In step 504, the control module 500 turns off the bottom section 103 to save power.

In step 505, the control module 500 controls the top section 101 and the bottom section 103 to cooperatively display the operation interface 1013.

While various embodiments have been described, it is to be understood that the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. An electronic device, comprising:
a display configured for displaying an operation interface when the electronic device is powered on, the display comprising:
a top section configured for displaying a part of the operation interface; and
a bottom section configured for displaying the other part of the operation interface; a battery for providing power to the display;
a battery detection module configured for continuously detecting a residual electrical energy of the battery and for determining whether the residual electrical energy is lower than a predetermined threshold; and
a control module configured for turning off the top section or the bottom section when the residual electrical energy is lower than the predetermined threshold.

2. The electronic device of claim 1, wherein the control module turns off the bottom section when the residual electrical energy is lower than the predetermined threshold.

3. The electronic device of claim 2, further comprising an interaction module configured for generating a query message when the electrical energy is lower than predetermined threshold, wherein the query message is displayed as a dialog box on the top section to prompt a user as to whether to choose a power saving mode of the electronic device.

4. The electronic device of claim 3, further comprising a charging detection module configured for detecting whether the battery is being charged by monitoring the residual electrical energy, wherein when the residual electrical energy is in an increasing state, the charging detection module determines that the battery is being charged.

5. The electronic device of claim 4, wherein the charging detection module generates a restart signal that is sent to the control module when the battery is being charged, and the control module turns on the bottom section again when receiving the restart signal.

6. The electronic device of claim 1, wherein the electronic device is a cell phone.

7. The electronic device of claim 1, wherein the predetermined threshold is about 10% of a capacity of the battery.

8. The electronic device of claim 1, wherein the top section and the bottom section both comprise a plurality of pixels which are programmatically controlled.

9. A method for saving power in an electronic device, the method comprising:
providing an electronic device having a display for displaying an operation interface, the display comprising a top section for displaying one part of the operation interface and a bottom section for displaying the other part of the operation interface;
detecting a residual electrical energy of a battery of the electronic device;
determining whether the residual electrical energy is lower than a predetermined threshold; and
turning off a selected one of the top section and the bottom section when the residual electrical energy is lower than the predetermined threshold.

10. The method of claim 9, further comprising:
controlling the top section and the bottom section to remain turned on when the residual electrical energy is equal to or higher than the predetermined threshold.

11. The method of claim 9, further comprising:
prompting a user of the electronic device to choose a power saving mode when the residual electrical energy is lower than the predetermined threshold, and on condition that the user chooses the power saving mode, proceeding to turn off the selected one of the top section and the bottom section.

12. The method of claim 11, further comprising:
controlling the top section and the bottom section to remain turned on, on condition that the user does not choose the power saving mode.

13. The method of claim 9, further comprising:
determining whether the battery is being charged after turning off the selected one of the top section and the bottom section, and on condition that the battery is being charged, turning on the selected one of the top section and the bottom section again.

14. An electronic device, comprising:
a display configured for displaying an operation interface when the electronic device is powered on, the display comprising:
a first section configured for displaying a predetermined portion of an area of the operation interface; and
a second section configured for displaying the remaining portion of the area of the operation interface;
a battery for providing power to the display;
a battery detection module configured for periodically sampling a current charge of the battery and for determining whether the current charge is lower than a predetermined threshold; and
a control module configured for turning off a selected one of the first section and the second section when the current charge is lower than the predetermined threshold.
